(19) United States
(12) Patent Application Publication
(10) Pub. No.: US 2014/0216255 A1
(43) Pub. Date: Aug. 7, 2014

(54) PHASED ENERGY ACCUMULATION BY KEEPING PRODUCTION FROM OTHERWISE WASTED ENERGY RESOURCES

(71) Applicant: Dennis W. Johnson, Simpsonville, SC (US)

(72) Inventor: Dennis W. Johnson, Simpsonville, SC (US)

(21) Appl. No.: 14/115,994

(22) PCT Filed: May 4, 2012
(86) PCT No.: PCT/US12/36506

§ 371 Date: Feb. 10, 2014

Related U.S. Application Data
(60) Provisional application No. 61/483,457, filed on May 6, 2011.

(51) Int. Cl. B01D 53/14

(52) U.S. Cl. CPC B01D 53/1412
USPC 95/156; 96/156

(57) ABSTRACT

Systems and methods are described for maximizing energy available for sale from a power plant during a peak demand period. An acid gas removal unit can include a lean solvent storage tank, a rich solvent storage tank, a stripper, and an acid gas compressor, which are fluidly coupled to an absorber to allow formation of rich solvent from lean solvent in the absorber. Stripper and compressor duties can be reduced or eliminated as a function of an increased power production. Rich solvent produced during the peak demand period can be stored in the rich solvent storage tank, and the lean solvent storage tank can store an amount of lean solvent sufficient to produce the rich solvent during the peak demand period.

This application claims the benefit of priority to U.S. provisional application having Ser. No. 61/483,457 filed on May 6, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is carbon capture systems and processes.

### BACKGROUND

Electrical generating plants are typically designed to operate at a maximum power production or load, but a plant's actual load often cycles with demand. Many power plants will have peak periods, especially in the summer in the south or the winter in the north, when the power plants will run at, or near, full load because of heightened energy demands. At off-peak periods, the power plants will then reduce load.

Due to government regulations, power plants may be required to include post combustion carbon capture systems. With the addition of these systems, more power will be used within the power plant. Such systems are generally not attached to power plants that produce electricity as their primary product, but where they have been, the capacity of the CO₂ capture process is much lower than the capacity of the power plant. During periods of peak power demands, power plants having carbon capture systems generally reduce the output of the power plant or include additional electrical generating equipment to meet the additional power requirements of the carbon capture systems. Thus, the carbon capture systems disadvantageously use energy during peak loads of power plants, which reduces the amount of electricity available for sale to the grid when the electricity typically has its highest value.

U.S. patent appl. no. 2009/0031630 to Naphad, et al. (publ. February 2009) discusses channeling rich solvent to a storage tank to be later channeled to a stripper during periods of lower stripper duty. U.S. patent appl. no. 2010/0005966 to Wibberley (publ. January 2010) discusses using solar energy to facilitate CO₂ capture. U.S. patent appl. no. 2008/0060521 to Hughes (publ. March 2008) discusses storing rich solvent to manage variable pressure absorbers and power plant start-up. However, Naphad's, Wibberley's, and Hughes' systems each fails to address energy efficiency or energy production maximization in light of the power requirements of carbon capture processes.

Thus, there is still a need for systems and methods that manage the energy required by carbon capture processes in a power plant by using reserve capacity of a power plant during off-peak operation.

### SUMMARY OF THE INVENTION

The inventive subject matter provides apparatus, systems and methods for maximizing energy available for sale from a power plant during a peak demand period. As used herein, the term “peak demand period” means a period of time when power demand is sustained at a significantly higher than average demand level, and specifically, a period of time when the power demand is at least 80% of the power plant's supply when the plant operates at full capacity. The full capacity of a power plant could depend upon the operational status of the plant, and could vary depending upon maintenance and other required downtime of plant components. For example, the peak demand period might occur daily, weekly, monthly, or seasonally, depending on the locale. The peak demand period could last for one hour, or more likely at least two hours, at least four hours, at least six hours, at least eight hours, or at least twelve hours or more.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

In order to maximize energy available for sale by the power plant, rich solvent produced by an absorber can be stored during a peak demand period, such that processing of the rich solvent and the energy requirements can be postponed until a non-peak demand period. This advantageously allows a gas removal unit to consume less power by reducing or preferably eliminating a stripper duty and a compressor duty in a gas removal unit as a function of increased power production. This is critical as the stripper and compressor together represent about 75% of the power required by the gas removal unit. In this manner, additional energy that would have otherwise been used by the gas removal unit can be sent directly to the grid for sale, which can thereby increase energy sales during peak demand periods.

A lean solvent storage tank can also be provided that is configured to store lean solvent in an amount sufficient to produce rich solvent during the peak demand period. In this manner, at least a portion of the stored lean solvent can be fed to an absorber during a peak demand period to allow formation of rich solvent from the lean solvent. The rich solvent can then be stored, as necessary, during peak demand periods, for later processing by the gas removal unit during a non-peak demand period to produce a lean solvent that can stored in the lean solvent storage tank. In preferred embodiments, the gas removal unit is configured to remove carbon dioxide from the rich solvent.

In an exemplary embodiment, a power plant can have a peak demand period of 12 hours. To account for this demand period, the gas removal unit can include a lean solvent storage tank and a rich solvent storage tank, each of which is configured to each store at least twelve hours' worth of lean and rich solvent, respectively. Thus, during the twelve hour period, the stripper and compressor can be shut down, which increases the amount of power for sale. Preferably, the lean solvent storage tank has an initial volume of lean solvent sufficient to produce rich solvent in the absorber during the twelve hour period. The stored lean solvent can be fed into an absorber, which processes a feed gas and captures carbon dioxide in a rich solvent. The rich solvent can then be stored in the rich solvent storage tank at least until the peak demand period has ended.

During the non-peak demand period, the stripper and compressor can be operated to process the stored rich solvent to produce a lean solvent stream that can be stored in the lean solvent storage tank for use during a subsequent peak demand period. Thus, the lean solvent can be used in a closed cycle. Because of the variable duty of the gas removal unit, the necessary equipment for the stripper, compressors, reboiler, and associated systems and subsystems should be sized for the higher processing capacity of the non-peak demand period processing.

The inventive concepts discussed herein can be used with combustors that are fired with coal, oil, coke, biomass, gas and other carbon containing fuels, for example, and that produce steam or electricity. It is also contemplated that the concepts could be applied to integrated gasification combined cycle (IGCC). The carbon dioxide capture process is considered post combustion because the process removes CO₂ from combustion gases and can be operated at a relatively constant pressure near atmospheric.

In one aspect, methods are contemplated that reduce energy requirements during peak operation of a power plant. In a preferred embodiment, rich solvent can be stored during peak operation of the power plant, and can be processed during off-peak operation to produce compressed CO₂ gas. This would advantageously allow sales of electrical power produced by the power plant to be increased when electricity demand is high and the price of units of power is highest.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a power plant configured to maximize energy sales.

FIG. 2 is a schematic an alternative embodiment of a power plant configured to maximize energy sales.

FIG. 3 is a schematic of an embodiment of a gas removal system.

FIG. 4 is a method of maximizing energy available for sale from a power plant during a peak demand period.

FIG. 5 is another method of maximizing energy available for sale from a power plant during a peak demand period.

### DETAILED DESCRIPTION

One should appreciate that the disclosed systems and methods provide many advantageous technical effects including energy management to both minimize the impact of power required for CO₂ sequestration and maximize the profit from sale of electricity from a power plant.

One major advantage is that power plants have added flexibility to maximize income from power sales without purchasing costly additional power generating capacity, such as gas turbines (combined cycle), additional plant steam and electrical power, and so forth. Rich solvent can also be stored to allow routine repairs of the rich solvent processing equipment and CO₂ compressors. This also allows the amount of spare equipment in the stripping and compressing processes to be reduced because maintenance can be accomplished while the equipment is out of service. Another advantage is that storage of the rich solvent allows for a period of operation of the CO₂ absorber when there is a problem in the CO₂ transport operation at the power plant (e.g., maintenance at the injection wells). A further advantage is the elimination of the make-up or fresh solvent storage system because of the power plant's increased storage capacity. Finally, the delayed processing of the rich solvent can allow the power plant and CO₂ absorber to operate at more consistent loads.

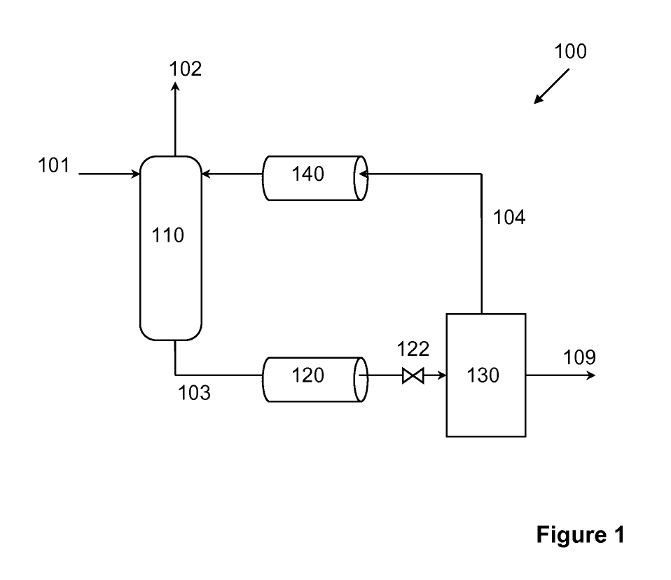

FIG. 1 illustrates a system 100 that maximizes energy available for sale from a power plant during a peak demand period. The system 100 can include a gas removal unit 130 having a stripper and compressor (not shown) that typically use power in the form of electrical energy and steam. The gas removal unit 130 can be fluidly coupled to a lean solvent storage tank 140 and a rich solvent storage tank 120, which can each be fluidly coupled to an absorber 110. While a single tank for each of the lean and rich solvents is discussed, additional tanks could be used or the tank could be replaced with another storage means such as a vessel or basin, for example.

Advantageously, duties of the stripper and compressor in the gas removal unit 130 can be reduced as a function of an increased power demand. Thus, during a peak demand period, for example, the duties of the stripper and compressor can be reduced, and preferably eliminated, such that the power requirement of the gas removal unit 130 can be significantly reduced, which thereby increases the amount of power from the power plant available for sale. During periods of peak power demand, stored lean solvent can be fed into the absorber 110 from the lean solvent storage tank 140 to produce rich solvent 103 from a feed gas stream 101. The rich solvent 103 can be stored in the rich solvent storage tank 120 for later processing by gas removal unit 130.

As shown in FIG. 1, a feed gas stream 101 can be fed into absorber 110 to produce a rich solvent 103 and a clean gas 102. The rich solvent 103 can be fed into rich solvent storage tank 120 to await processing by the gas removal unit 130. Valve 122 can be opened or closed, as needed, depending on the level of compressor and stripper duties in the gas removal unit 130. As rich solvent is fed into the gas removal unit 130, a lean solvent 104 can be produced and fed into the lean solvent storage tank 140. A compressed gas stream 109 can exit the gas removal unit 130. In some contemplated embodiments, the gas removal unit 130 is configured to remove carbon dioxide from the rich solvent 103.

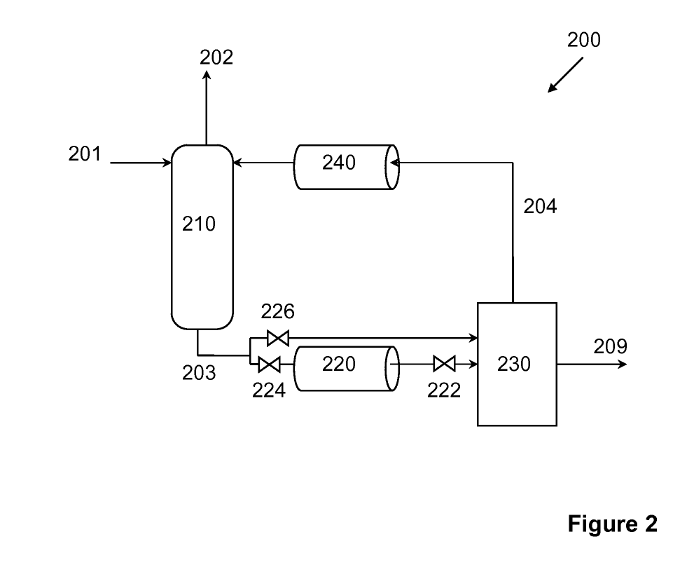

In FIG. 2, an alternative system 200 is shown for maximizing energy available for sale from a power plant during a peak demand period. A rich solvent 203 produced by absorber 210 can be fed into a rich solvent storage tank 220 and/or directly into a gas removal unit 230, depending upon the status (e.g., open or closed) of valves 224 and 226, respectively. With respect to the remaining numerals in FIG. 2, the same considerations for like components with like numerals of FIG. 1 apply.

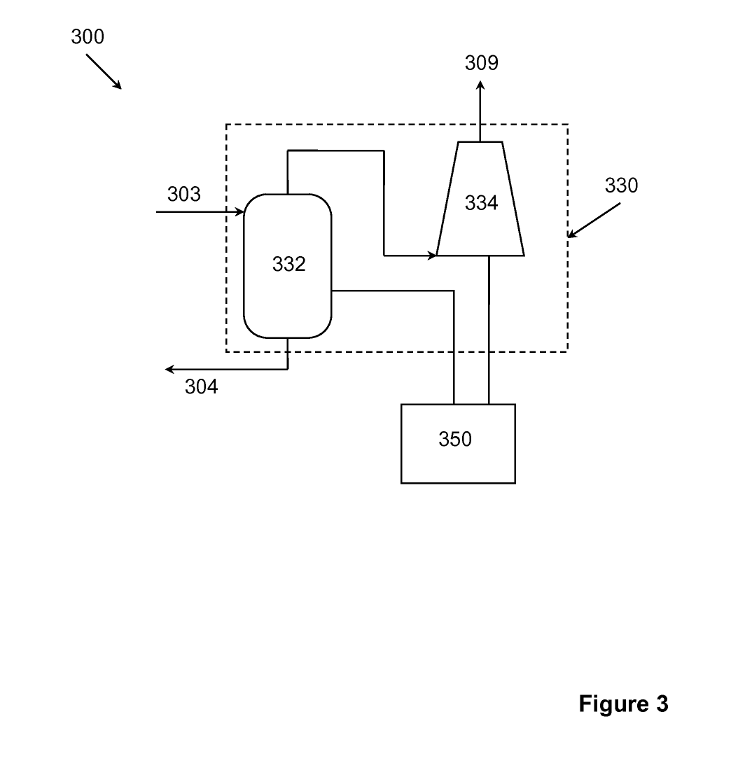

FIG. 3 illustrates a gas removal system 300 having a control circuit 350 configured to allow reduction or elimination of the duties of components in a gas removal unit 330. For example, the control circuit 350 can be electronically coupled to a stripper 332 and a compressor 334 such that the duties of each of the stripper 332 and compressor 334 can be reduced or eliminated as a function an increased power demand. Thus, for example, during a peak demand period, the compressor 334 and stripper 332 can be shut down, or operated in a manner in which the power requirements of the stripper and compressor are reduced, so that additional energy can be sent to the grid for sale. It is contemplated that the control circuit 350 can analyze many variables to determine whether to reduce or eliminate the duties of the stripper 332 and compressor 334 including, for example, power demand, power sales, and associated profit potential. With respect to the remaining numerals in FIG. 3, the same considerations for like components with like numerals of FIG. 1 apply.

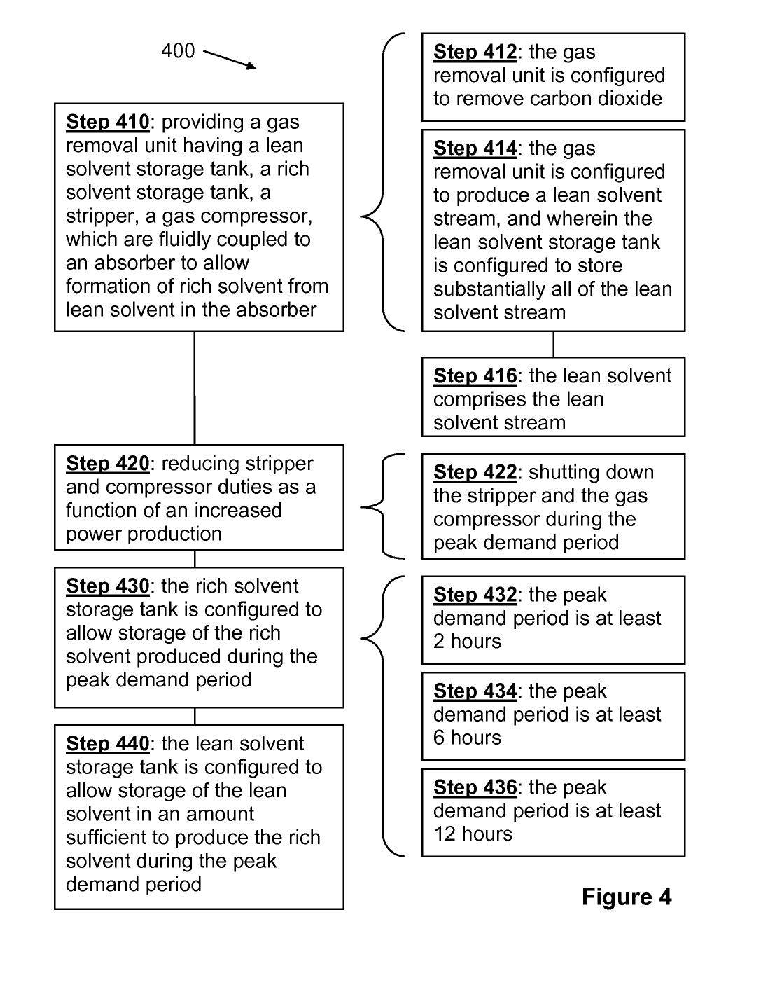

In FIG. 4, a method 400 is shown for maximizing energy available for sale from a power plant during a peak demand period. In step 410, a gas removal unit can be provided having a lean solvent storage tank, a rich solvent storage tank, a stripper, and one or more gas compressors. These components can be fluidly coupled to an absorber to allow formation of rich solvent in the absorber from lean solvent.

In step 412, the gas removal unit is preferably configured to remove carbon dioxide from a feed gas from the power plant, although removal of other gases is also contemplated. In step 414, the gas removal unit can be configured to produce a lean solvent stream, and the lean solvent storage tank can be configured to store substantially all of the lean solvent stream. It is contemplated that the lean solvent stored in the lean solvent storage tank can include some or all of the lean solvent stream.

In step 420, duties of a stripper and a compressor can be reduced as a function of an increased power production by the power plant. This is contrary to normal operation of existing systems, as such systems would typically increase the duties of a stripper and compressor during periods of increased power production because of the increased rich solvent produced by the absorber. In step 422, the stripper and the compressor can be shut down during a peak demand period, which allows additional energy to be sent to the grid for sale.

In step 430, the rich solvent storage tank can be configured to allow storage of the rich solvent produced during the peak demand period, such that processing of the rich solvent can be postponed during peak demand periods. In step 440, the lean solvent storage tank can be configured to allow storage of the lean solvent in an amount sufficient to produce the rich solvent during the peak demand period. The peak demand period can be at least two hours (step 432), at least six hours (step 434), at least twelve hours (step 436), or more.

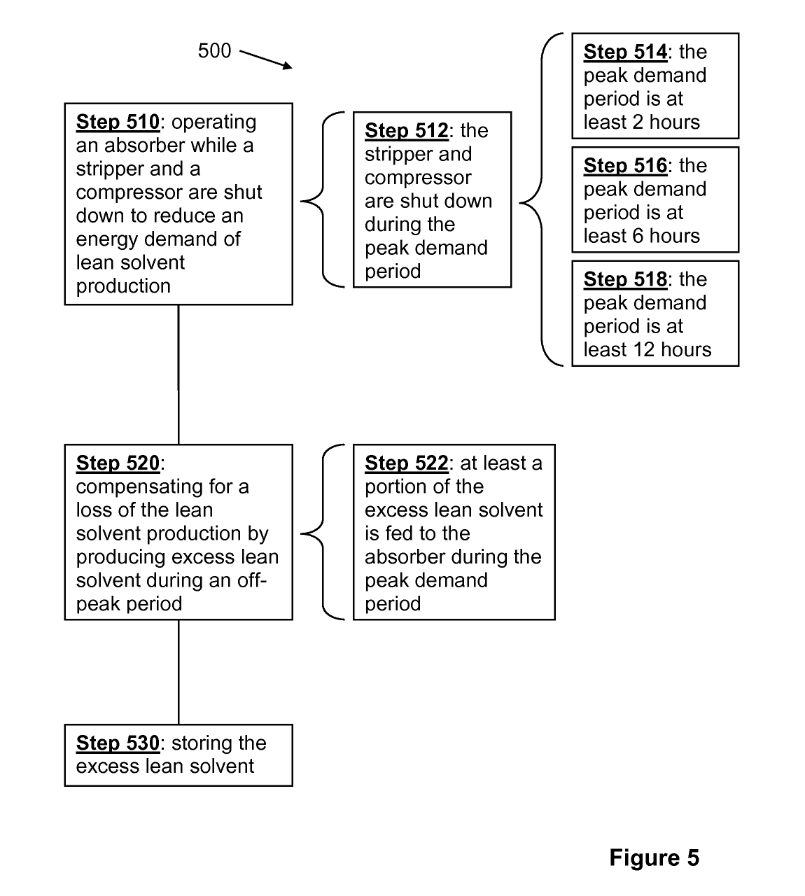

FIG. 5 illustrates another method 500 of maximizing energy available for sale from a power plant during a peak demand period. In step 510, an absorber can be operated while a stripper and a compressor are shut down to reduce an energy demand of lean solvent production. In preferred embodiments, the stripper and a compressor can be shut down in step 512 during the peak power demand. It is contemplated that the peak demand period can be at least two hours (step 514), at least six hours (step 516), at least twelve hours (step 518), or longer.

A loss of the lean solvent production during the peak demand period can be compensated for in step 520 by producing excess lean solvent in an absorber during an off-peak period. In step 530, the excess lean solvent can be stored, preferably in a lean solvent storage tank.

In step 522, at least a portion of the stored excess lean solvent can be fed to the absorber during the peak demand period.

In other contemplated embodiments, the sale of energy produced by a power plant can be maximized by storing pressurized water during a non-peak demand period, such that the pressurized water can be used by the stripper(s) to process rich solvent during a peak demand period. Although steam could alternatively be stored, this is less practical. It is alternatively contemplated that pumped storage could be used, such that additional electricity needed to power the gas removal unit can be stored during a non-peak demand period. This water can then be used to generate additional electricity during a peak demand period such as via a turbine or other means.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of maximizing energy available for sale from a power plant during a peak demand period, comprising:
providing a gas removal unit having a lean solvent storage tank, a rich solvent storage tank, a stripper, a gas compressor, which are fluidly coupled to an absorber to allow formation of rich solvent from lean solvent in the absorber;
reducing stripper and compressor duties as a function of an increased power production;
wherein the rich solvent storage tank is configured to allow storage of the rich solvent produced during the peak demand period; and
wherein the lean solvent storage tank is configured to allow storage of the lean solvent in an amount sufficient to produce the rich solvent during the peak demand period.

2. The method of claim 1, wherein the gas removal unit is configured to remove carbon dioxide.

3. The method of claim 1, wherein the peak demand period is at least two hours.

4. The method of claim 1, wherein the peak demand period is at least six hours.

5. The method of claim 1, wherein the peak demand period is at least twelve hours.

6. The method of claim 1, wherein the gas removal unit is configured to produce a lean solvent stream, and wherein the lean solvent storage tank is configured to store substantially all of the lean solvent stream.

7. The method of claim 6, wherein the lean solvent comprises the lean solvent stream.

8. The method of claim 1, wherein the step of reducing the stripper and compressor duties further comprises shutting down the stripper and the gas compressor during the peak demand period.

9. A method of maximizing energy available for sale from a power plant during a peak demand period, comprising:
operating an absorber while a stripper and a compressor are shut down to reduce an energy demand of lean solvent production;
compensating for a loss of the lean solvent production by producing excess lean solvent during an off-peak period; and
storing the excess lean solvent.

10. The method of claim 9, wherein at least a portion of the excess lean solvent is fed to the absorber during the peak demand period.

11. The method of claim 9, wherein the stripper and compressor are shut down during the peak demand period.

12. The method of claim 11, wherein the peak demand period is at least two hours.

13. The method of claim 11, wherein the peak demand period is at least six hours.

14. The method of claim 11, wherein the peak demand period is at least twelve hours.

15. A gas removal system, comprising a control circuit configured to allow reduction or elimination of a stripper duty and a compressor duty as a function an increased power demand.

16. The system of claim 15, wherein the control circuit is configured to allow elimination of the stripper and compressor duties as the function of the increased power demand.
